(19) United States
(12) Patent Application Publication
(10) Pub. No.: US 2008/0174142 A1
(43) Pub. Date: Jul. 24, 2008

(54) Truck Cover Systems

(76) Inventor: Jesse M. Pearlman, New Auburn, WI (US)

Correspondence Address: STONEMAN LAW OFFICES, LTD, 3770 NORTH 7RD STREET, Suite 100, PHOENIX, AZ, 85014, US

(21) Appl. No.: 12/017,304

(22) Filed: Jan. 21, 2008

Related U.S. Application Data
(60) Provisional application No. 60/886,074, filed on Jan. 22, 2007.

(51) Int. Cl. B60P 7/02

(52) U.S. Cl. 296/100.1

(57) ABSTRACT

A system for covering the cargo bed of a truck is provided having a motorized drive system which stores entirely within the primary cover of the system. Screw shaft connectors provide for automated opening of the cover vertically from the cargo bed of the truck. Demountable enclosure parts, stored within the cover when the cover is closed, are also provided for enclosing the truck bed when the cover is open. The primary cover comprises a removable cover portion that is stored over the cab of the truck.

### CROSS REFERENCE TO RELATED APPLICATION

The present application is related to and claims priority from prior provisional application Ser. No. 60/886,074, filed Jan. 22, 2007, entitled “TRUCK COVER SYSTEMS”, the content of which is incorporated herein by this reference and is not admitted to be prior art with respect to the present invention by the mention in this cross-reference section.

### BACKGROUND

This invention relates to providing improved truck cover systems. More particularly, this invention relates to providing improved truck cover systems which are convenient to operate, and which rise perpendicularly from the bed of a truck.

Typically, persons needing to store items in their truck bed install a cover in order to protect those items. Such covers are difficult to operate and are labor intensive to open. In addition, substantial effort must typically be made to install these covers.

Therefore, a need exists for a truck cover system that is not labor intensive to open. Further, a need exists for a truck cover system which is easy to operate and install.

### OBJECTS AND FEATURES OF THE INVENTION

A primary object and feature of the present invention is to solve the above-mentioned problems and meet the above-listed needs. A further primary object and feature of the present invention is to provide truck cover systems.

It is a further object and feature of the present invention to provide such a system that is attached to the walls lining the bed of a truck. It is another object and feature of the present invention to provide such a system that rises substantially perpendicular to the bed of a truck.

It is yet another object and feature of the present invention to provide such a system having a screw-type connection between the cover and the truck. It is a further object and feature of the present invention to provide such a system having motorized movement of the cover. In addition, it is an object and feature of the present invention to provide such a system that has storage compartments.

It is yet another object and feature of the present invention to provide such a system having parts for enclosing the cover and a portion of the truck, when the cover is open. It is a further object of the present invention to provide such a system having a storage compartment for the demountable enclosure parts. In addition, it is an object and feature of the present invention to have a storage compartment for a wheel.

It is yet another object and feature of the present invention to provide such a system having a second cover attached to the primary cover. It is a further object of the present invention to provide such a system having a second cover arranged for movement to the roof of the truck. In addition, it is an object and feature of the present invention to have light projectors on these covers.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a system, related to covering at least one cargo bed of at least one truck having at least one cab, such system comprising: at least one bed cover, having at least one inner surface and at least one outer surface, such at least one bed cover structured and arranged to substantially cover the at least one cargo bed; and at least one first connector structured and arranged to connect such at least one bed cover to the at least one cargo bed; wherein such at least one bed cover comprises at least one motorizer structured and arranged to motorize movement of such at least one bed cover; wherein such at least one motorizer is located substantially adjacent such at least one inner surface; wherein such at least one first connector comprises at least one screw shaft; and wherein such at least one motorizer is structured and arranged to move such at least one bed cover substantially along the axis of such at least one screw shaft. Moreover, it provides such a system wherein: the axis of such at least one screw shaft comprises a substantially vertical orientation; and such at least one bed cover is structured and arranged to translate substantially vertically between at least one bed-covering position located substantially adjacent the at least one cargo bed and at least one raised position located above the at least one cargo bed.

Additionally, it provides such a system further comprising at least one demountable enclosure structured and arranged to demountably enclose at least one open area formed substantially between the at least one cargo bed and such at least one bed cover, when such at least one bed cover is moved to such at least one raised position. Also, it provides such a system wherein such at least one bed cover comprises at least one enclosure storage structured and arranged to store such at least one demountable enclosure when demounted from the at least one cargo bed. In addition, it provides such a system further comprising: at least one in-bed storage unit structured and arranged to assist in-bed storage of at least one item substantially within the at least one cargo bed; wherein such at least one bed cover comprises at least one storage access portion structured and arranged to provide access to such at least one in-bed storage unit when such at least one bed cover is in such at least one bed-covering position.

And, it provides such a system wherein such at least one bed cover comprises: at least one repositionable cover portion structured and arranged to provide partial access to the at least one cargo bed when such at least one bed cover is in such at least one bed-covering position; and at least one second connector structured and arranged to substantially connect such at least one repositionable cover portion to such at least one bed cover; wherein such at least one second connector comprises at least one relocator structured and arranged to relocate such at least one repositionable cover portion from at least one stowed position substantially within such at least one bed cover to at least one deployed position substantially adjacent the at least one cab; and wherein, when such at least one repositionable cover portion is in such at least one deployed position, access to the at least one cargo bed is provided. Further, it provides such a system wherein such relocation of such at least one repositionable cover portion by such at least one relocator is assisted by such at least one motorizer.

Even further, it provides such a system wherein such at least one second connector comprises: at least one detacher structured and arranged to enable detachment of such at least one second connector from such at least one bed cover; wherein such at least one bed cover comprises at least one connector storage structured and arranged to store such at least one second connector; wherein such at least one second connector is storable within such at least one connector storage after such detachment. Moreover, it provides such a system wherein such at least one bed cover comprises at least one illuminator structured and arranged to provide illumination adjacent the at least one truck. Additionally, it provides such a system wherein such at least one illuminator comprises: at least one third connector structured and arranged to connect such at least one illuminator to such at least one bed cover; wherein such at least one third connector comprises at least one pivot structured and arranged to assist pivotal movement of such at least one illuminator relative to such at least one bed cover.

Also, it provides such a system wherein such at least one bed cover comprises at least one wheel storage area structured and arranged to store at least one road wheel of the at least one truck. In addition, it provides such a system wherein: such at least one first connector comprises at least one threaded collar structured and arranged to collar such at least one screw shaft; and such at least one threaded collar is fixedly coupled to the at least one cargo bed; such at least one motorizer is structured and arranged to rotate at least one screw shaft; such at least one threaded collar is maintained in a substantially fixed position relative to the at least one cargo bed during such rotation; and such rotation of such at least one screw shaft results in a substantially vertical translational movement of such at least one screw shaft through such at least one threaded collar. And, it provides such a system wherein such at least one first connector further comprises: at least four of such at least one screw shafts operationally engaging a matching number of such at least one threaded collars; wherein such at least one motorizer comprises at least one drive train structured and arranged to contemporaneously rotate each one of such at least one screw shafts.

Further, it provides such a system wherein such at least one drive train comprises: at least one electrically driven motor structured and arranged to provide at least one rotational force; coupled to such at least one electrically driven motor, as least one rotational shaft structured and transfer such at least one rotational force away from such at least one electrically driven motor; and at least one worm gear structured and arranged to adjust torque levels within such at least one drive train. Even further, it provides such a system wherein: such at least one bed cover comprises at least four peripheral corners; and each one of such at least four peripheral corners comprises one such at least one screw shaft. Moreover, it provides such a system further comprising at least one controller structured and arranged to control motorized operation of such at least one motorizer. Additionally, it provides such a system further comprising at least one selectable power director structured and arranged to selectably direct such at least one rotational force between such at least one first connector and such at least one second connector. Also, it provides such a system wherein such at least one relocator comprises: at least one roller structured and arranged to assist rolling movement of such at least one repositionable cover portion from such at least one stowed position to such at least one deployed position; at least one guide track structured and arranged to guide such at least one roller during such rolling movement.

In addition, it provides such a system wherein such at least one relocator comprises: at least one roller structured and arranged to assist rolling movement of such at least one repositionable cover portion from such at least one stowed position to such at least one deployed position; at least one guide track structured and arranged to guide such at least one roller during such rolling movement; and at least one positional lock structured and arranged to positionally lock such at least one repositionable cover portion in such at least one deployed position; wherein such at least one guide track comprises at least one cover-mounted portion structured and arranged to assist such rolling movement over such at least one bed cover, and at least one cab-mounted portion structured and arranged to assist such rolling movement over the at least one cab.

In accordance with another preferred embodiment hereof, this invention provides a system, related to covering at least one cargo bed of at least one truck having at least one cab, such system comprising: at least one bed cover structured and arranged to cover the at least one cargo bed; and at least one first connector structured and arranged to movably connect such at least one bed cover to the at least one cargo bed; wherein such at least one first connector comprises at least one screw shaft; and wherein such at least one bed cover comprises at least one hand crank structured and arranged to assist in the performance of at least one hand-cranked rotation of such at least one screw shaft; wherein the axis of such at least one screw shaft comprises a substantially vertical orientation; wherein such hand-cranked rotation of such at least one screw shaft moves such at least one bed cover substantially along the axis of such at least one screw shaft between at least one bed-covering position located substantially adjacent the at least one cargo bed and at least one raised position located above the at least one cargo bed.

In accordance with another preferred embodiment hereof, this invention provides a system, related to at least one truck having at least one cab and at least one cargo bed, such system comprising: at least one cargo-bed cover structured and arranged to substantially cover such at least one cargo bed; at least one repositionable cover portion structured and arranged to provide partial access to the at least one cargo bed when covered by such at least one cargo bed cover; and at least one connector structured and arranged to connect such at least one repositionable cover portion to such at least one bed cover; wherein such at least one connector comprises at least one relocator structured and arranged to relocate such at least one repositionable cover portion from at least one stowed position substantially within such at least one bed cover to at least one deployed position substantially adjacent the at least one cab; and wherein, when such at least one repositionable cover portion is in such at least one deployed position, partial access to the at least one cargo bed is provided.

In accordance with another preferred embodiment hereof, this invention provides a system, related to at least one truck having at least one cargo-bed cover having at least one motorizer, comprising the steps of: packaging the at least one cargo-bed cover; and selling the at least one cargo-bed cover; wherein the at least one cargo-bed cover comprises the at least one motorizer.

In accordance with another preferred embodiment hereof, this invention provides a method related to covering at least one cargo bed of at least one truck, such method comprising the steps of: mounting at least one screw shaft receiver in the at least one cargo bed; and mounting at least one screw shaft in the at least one screw shaft receiver; coupling at least one motor-driven rotator to such at least one screw shaft; mounting at least one cargo-bed cover to such at least one screw shaft; wherein rotation of the at least one screw shaft by the at least one motor-driven rotator provides movement of the at least one bed cover substantially along the at least one screw shaft.

In accordance with a preferred embodiment hereof, this invention provides a system, related to at least one truck having at least one roof, comprising: bed cover means for covering the at least one truck, having at least one inner surface and at least one outer surface; and first connector means for connecting such bed cover means to the at least one truck; wherein such bed cover means comprises motorizer means for motorized movement of such bed cover means; wherein such motorizer means is located substantially between such at least one inner surface and such at least one outer surface; wherein such first connector means comprises at least one screw; and wherein such motorizer means is structured and arranged to move such bed cover means substantially along the axis of such at least one screw. Moreover, it provides such a system further comprising demountable enclosure means for enclosing such bed cover means and at least one cargo bed of the at least one truck.

Additionally, it provides such a system wherein such bed cover means comprises bed storage means for storing at least one item. Also, it provides such a system further comprising: demountable enclosure means for enclosing such bed cover means and at least one cargo bed of the at least one truck; wherein such bed cover means comprises second storage means for storing such demountable enclosure means. In addition, it provides such a system wherein such motorizer means comprises at least one worm gear. And, it provides such a system wherein such bed cover means comprises: second cover means for covering at least one second portion of the at least one truck; and second connector means for connecting such second cover means to such bed cover means; wherein such second cover means is structured and arranged to move substantially onto the at least one roof. Further, it provides such a system wherein such bed cover means comprises: second cover means for covering at least one second portion of the at least one truck; second connector means for connecting such second cover means to such bed cover means; and attacher means for attaching such second cover means to the at least one roof.

Even further, it provides such a system wherein such bed cover means comprises: second cover means for covering at least one second portion of the at least one truck; second connector means for connecting such second cover means to such bed cover means; and wherein such motorizer means is structured and arranged to move such second cover means substantially onto the at least one roof. Moreover, it provides such a system wherein such bed cover means comprises: second cover means for covering at least one second portion of the at least one truck; second connector means for connecting such second cover means to such bed cover means; and third storage means for storing such second connector means; wherein such second connector means detaches and stores inside such third storage means. Additionally, it provides such a system wherein such bed cover means comprises projection means for projecting at least one light from the at least one truck. Also, it provides such a system wherein such bed cover means comprises: projection means for projecting at least one light from the at least one truck; wherein such projection means comprises third connector means for connecting such projection means to such bed cover means; and wherein such third connector means comprises at least one hinge. In addition, it provides such a system wherein such bed cover means comprises fourth storage means for storing at least one wheel. And, it provides such a system wherein: such first connector means comprises collar means for collaring such at least one screw; and such collar means remains stationarily connected to the at least one truck when such at least one screw is screwed. Further, it provides such a system further comprising controller means for controlling motorized movement of such motorizer means.

In accordance with another preferred embodiment hereof, this invention provides a system, related to at least one truck having at least one roof, comprising: bed cover means for covering the at least one truck; and first connector means for connecting such bed cover means to the at least one truck; wherein such bed cover means comprises crank means for cranked movement of such bed cover means; wherein such first connector means comprises at least one screw; and wherein such crank means moves such bed cover means substantially along the axis of such at least one screw.

In accordance with another preferred embodiment hereof, this invention provides a system, related to at least one truck having at least one roof, bed cover means, and first connector means, comprising: second cover means for covering the at least one truck; and second connector means for connecting such second cover means to the bed cover means; wherein such second cover means is structured and arranged to move substantially onto the at least one roof.

In accordance with another preferred embodiment hereof, this invention provides a system, related to at least one truck having at least one roof, comprising: at least one bed cover structured and arranged to cover the at least one truck, having at least one inner surface and at least one outer surface; and at least one first connector structured and arranged to connect such at least one bed cover to the at least one truck; wherein such at least one bed cover comprises at least one motorizer structured and arranged to motorize movement of such at least one bed cover; wherein such at least one motorizer is located substantially between such at least one inner surface and such at least one outer surface; wherein such at least one first connector comprises at least one screw; and wherein such at least one motorizer is substantially structured and arranged to move such at least one bed cover substantially along the axis of such at least one screw. Even further, it provides such a system further comprising at least one demountable enclosure structured and arranged to enclose such at least one bed cover and at least one cargo bed of the at least one truck.

Moreover, it provides such a system wherein such at least one bed cover comprises at least one bed storage unit structured and arranged to store at least one item. Additionally, it provides such a system further comprising: at least one demountable enclosure structured and arranged to enclose such at least one bed cover and at least one cargo bed of the at least one truck; wherein such at least one bed cover comprises at least one second storage structured and arranged to store such at least one demountable closure. Also, it provides such a system wherein such at least one motorizer comprises at least one worm gear. In addition, it provides such a system wherein such at least one bed cover comprises: at least one repositionable cover portion structured and arranged to cover at least one second portion of the at least one truck; and at least one second connector structured and arranged to substantially connect such at least one repositionable cover portion to such at least one bed cover; wherein such at least one repositionable cover portion is substantially structured and arranged to move substantially onto the at least one roof. And, it provides such a system wherein such at least one bed cover comprises: at least one repositionable cover portion structured and arranged to cover at least one second portion of the at least one truck; at least one second connector structured and arranged to connect such at least one repositionable cover portion to such at least one bed cover; and at least one attacher structured and arranged to attach such at least one repositionable cover portion to the at least one roof.

Further, it provides such a system wherein such at least one bed cover comprises: at least one repositionable cover portion structured and arranged to cover at least one second portion of the at least one truck; at least one second connector structured and arranged to connect such at least one repositionable cover portion to such at least one bed cover; and wherein such at least one motorizer is substantially structured and arranged to move such at least one repositionable cover portion substantially onto the at least one roof. Even further, it provides such a system wherein such at least one bed cover comprises: at least one repositionable cover portion structured and arranged to cover at least one second portion of the at least one truck; at least one second connector structured and arranged to connect such at least one repositionable cover portion to such at least one bed cover; and at least one third storage structured and arranged to store such at least one second connector; wherein such at least one second connector substantially detaches and stores inside such at least one third storage. Moreover, it provides such a system wherein such at least one bed cover comprises at least one projector structured and arranged to project at least one light from the at least one truck.

Additionally, it provides such a system wherein such at least one bed cover comprises: At least one projector structured and arranged to project at least one light from the at least one truck; wherein such at least one projector comprises at least one third connector structured and arranged to connect such at least one projector to such at least one bed cover; and wherein such at least one third connector comprises at least one hinge. Also, it provides such a system wherein such at least one bed cover comprises at least one fourth storage structured and arranged to store at least one wheel. In addition, it provides such a system wherein: such at least one first connector comprises at least one collar structured and arranged to collar such at least one screw; and such at least one collar remains stationarily connected to the at least one truck when such at least one screw is screwed. And, it provides such a system further comprising at least one controller structured and arranged to control motorized movement of such at least one motorizer.

In accordance with another preferred embodiment hereof, this invention provides a system, related to at least one truck having at least one roof, comprising: at least one bed cover structured and arranged to cover the at least one truck; and at least one first connector structured and arranged to connect such at least one bed cover to the at least one truck; wherein such at least one bed cover comprises at least one crank structured and arranged to crank movement of such at least one bed cover; wherein such at least one first connector comprises at least one screw; and wherein such at least one crank substantially moves such at least one bed cover substantially along the axis of such at least one screw.

In accordance with another preferred embodiment hereof, this invention provides a system, related to at least one truck having at least one roof, at least one bed cover, and at least one first connector, comprising: at least one repositionable cover portion structured and arranged to cover the at least one truck; and at least one second connector structured and arranged to connect such at least one repositionable cover portion to the at least one bed cover; wherein such at least one repositionable cover portion is substantially structured and arranged to move substantially onto the at least one roof.

In accordance with another preferred embodiment hereof, this invention provides a system, related to at least one truck having at least one bed cover having at least one motorizer, comprising the steps of: packaging the at least one bed cover; and selling the at least one bed cover; wherein the at least one bed cover comprises the at least one motorizer.

In accordance with another preferred embodiment hereof, this invention provides a system, related to at least one truck, at least one bed cover, at least one screw having at least one axis, and at least one screw hole, comprising the steps of: installing the at least one screw hole in the at least one truck; and installing the at least one screw in the at least one screw hole; wherein the at least one screw provides movement of the at least one bed cover substantially along the at least one axis of the at least one screw.

### BRIEF DESCRIPTION OF THE DRAWINGS

FIG. 1 shows a perspective view illustrating a truck cover system according to a preferred embodiment of the present invention.

FIG. 2 shows another perspective view of the truck cover system, according to the preferred embodiment of FIG. 1, in an open position.

FIG. 3 shows a perspective view of a second cover, according to the preferred embodiment of FIG. 1.

FIG. 4 shows a perspective view of demountable enclosure parts, according to the preferred embodiment of FIG. 1, in an installed position.

FIG. 5 shows a top view of a bed cover, according to the preferred embodiment of FIG. 1.

FIG. 6 shows an underside view of a bed cover, according to the preferred embodiment of FIG. 1.

FIG. 7 shows a motorizer, according to the preferred embodiment of FIG. 1.

FIG. 8 shows a perspective view of a motorizer according to the preferred embodiment of FIG. 1.

FIG. 9 shows another perspective view of a motorizer according to the preferred embodiment of FIG. 1.

FIG. 10 shows a perspective view of a worm gear according to the preferred embodiment of FIG. 1.

FIG. 11 shows another perspective view of a worm gear according to the preferred embodiment of FIG. 1.

FIG. 12 shows an above view of a motorizer raising the bed cover, according to the preferred embodiment of FIG. 1.

FIG. 13 shows an above view of a motorizer lowering the bed cover, according to the preferred embodiment of FIG. 1.

FIG. 14 shows a sectional view through the section 14-14 of FIG. 5 illustrating the worm gears and connectors, with the bed cover in a closed position, according to the preferred embodiment of FIG. 1.

FIG. 15 shows the enlarged side view 15 of FIG. 14 illustrating the worm gears and connectors, with the bed cover in a closed position, according to the preferred embodiment of FIG. 1.

FIG. 16 shows a side view of the worm gears and connectors, with the bed cover in an opened position, according to the preferred embodiment of FIG. 1.

FIG. 17 shows a blown-up side view of the worm gears and connectors, with the bed cover in an opened position, according to the preferred embodiment of FIG. 1.

FIG. 18 shows a side view illustrating a second cover retracting onto the roof of the truck according to the preferred embodiment of FIG. 1.

FIG. 19 shows a side view illustrating a second cover with detachable and storable second connectors, according to the preferred embodiment of FIG. 1.

FIG. 20 shows a perspective view of a wheel storage, according to another preferred embodiment of the present invention.

FIG. 21 shows a perspective view of a projecting light, according to another preferred embodiment of the present invention.

FIG. 22 shows a side view of the projecting light, according to the preferred embodiment of FIG. 21.

FIG. 23 shows a diagram illustrating another truck cover system according to another preferred embodiment of the present invention.

FIG. 24 shows a diagram illustrating another truck cover system according to another preferred embodiment of the present invention.

FIG. 25 shows a perspective view, illustrating an alternate truck cover mounted to the bed of a truck, according to a preferred embodiment of the present invention.

FIG. 26 shows a perspective view, illustrating the alternate truck cover in a raised position, according to the preferred embodiment of FIG. 25.

FIG. 27 shows a perspective view, illustrating the alternate truck cover in the raised position, with a repositionable cover portion transitioning upwardly to a moveable position, according to the preferred embodiment of FIG. 25.

FIG. 28 shows a perspective view of the repositionable cover portion of FIG. 27 translating toward a forward “stowed” position over the cab of the pickup truck.

FIG. 29 shows the repositionable cover portion of FIG. 27 in the stowed position over the cab of the pickup truck.

FIG. 30 shows a first schematic diagram illustrating the preferred operational arrangements of the repositionable cover portion of FIG. 27.

FIG. 31 shows a second schematic diagram illustrating the preferred operational arrangements of the secondary cover of FIG. 27.

FIG. 32 shows a third schematic diagram illustrating the preferred operational arrangements of the repositionable cover portion of FIG. 27.

FIG. 33 shows a fourth schematic diagram illustrating the preferred operational arrangements of the repositionable cover portion of FIG. 27.

### DETAILED DESCRIPTION OF THE BEST MODES AND PREFERRED EMBODIMENTS OF THE INVENTION

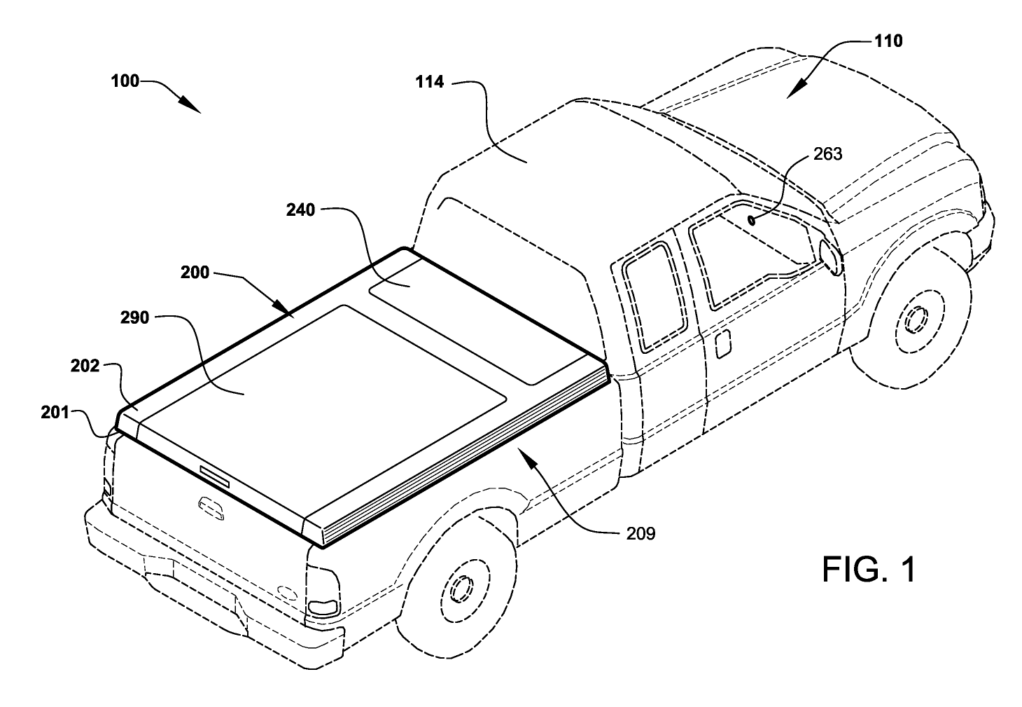

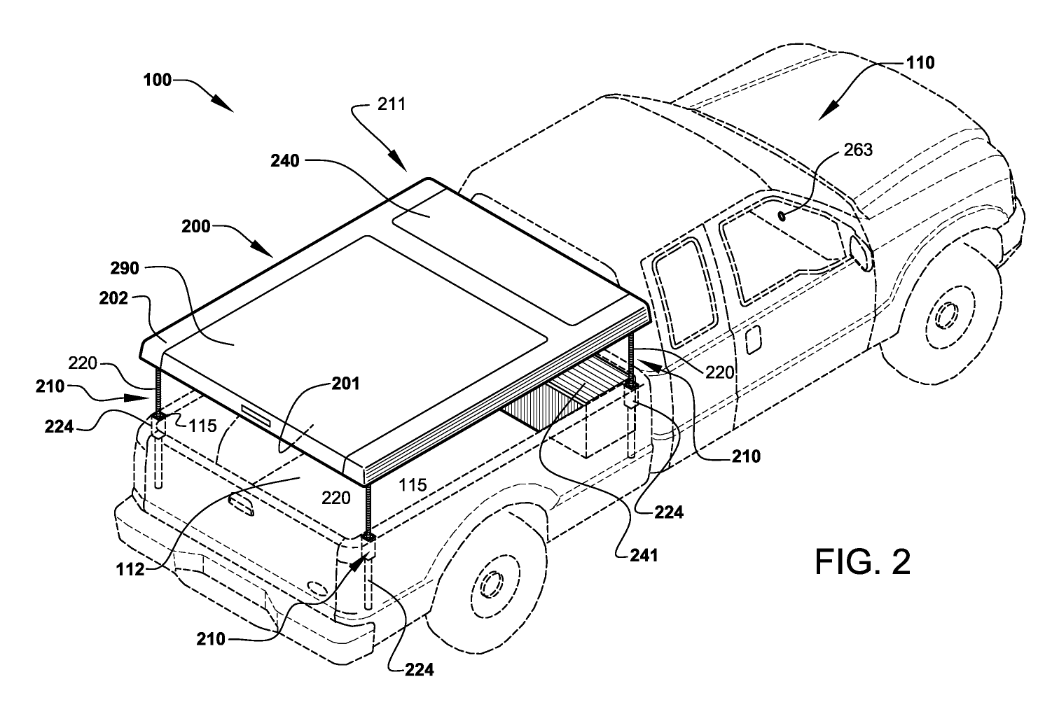

FIG. 1 shows a perspective view illustrating a truck cover system according to a preferred embodiment of the present invention. FIG. 2 shows another perspective view of the truck cover system, according to the preferred embodiment of FIG. 1, in an open position. Truck cover system 100 preferably provides coverage to portions of truck 110 having cargo bed 112 and cab 113. Truck cover system 100 preferably comprises bed cover 200, first connector 210, and motorizer 250, as shown. Bed cover 200 preferably comprises an inner surface 201 and an outer surface 202, as shown. First connector 210 preferably connects bed cover 200 to cargo bed 112, as shown. Motorizer 250 preferably provides motorized movement of bed cover 200, preferably vertically between a bed-covering position 209 located substantially adjacent the at least one cargo bed and at least one raised position 211 located above cargo bed 112, as shown.

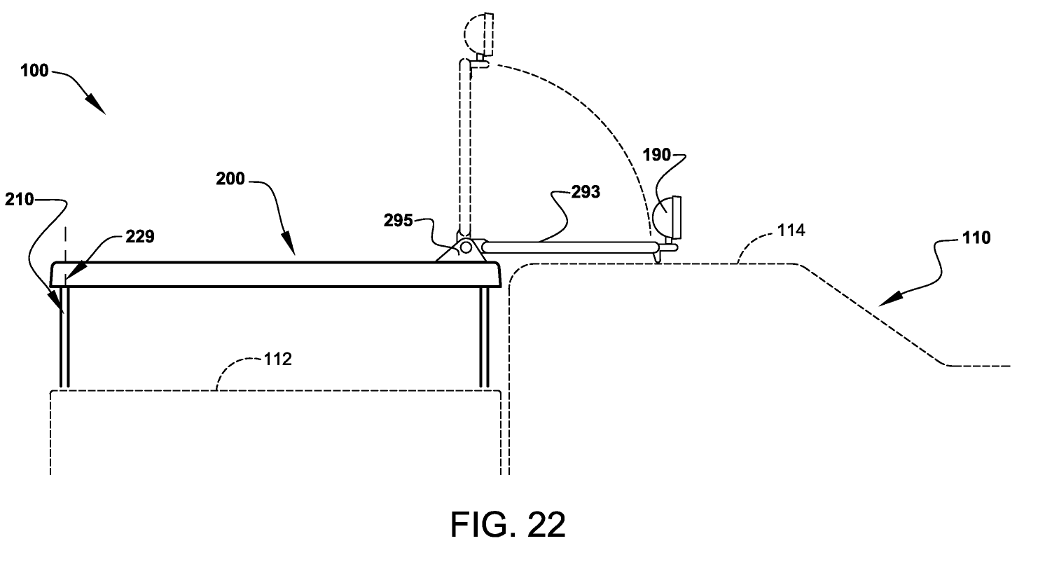

First connector 210 preferably comprises screw shaft 220, preferable four screw shafts 220, preferably located at each corner of cargo bed 112 so as to provide stable lifting and lowering of bed cover 200, as shown. Motorizer 250 is preferably adapted to move bed cover 200 substantially along the vertical axis 229 of screw shafts 220, as best shown in FIG. 22. First connector 210 preferably comprises collar 224, preferably four collars 224, preferably vertically positioned in the walls of bed 112, most preferably with the stake pockets 115, as shown. Collars 224 (at least embodying herein at least one screw shaft receiver) preferably remain in a fixed mounting position within cargo bed 112 when screw shafts 220 are rotated, preferably when rotated by motorizer 250. Upon reading the teachings of this specification, those with ordinary skill in the art will now understand that, under appropriate circumstances, considering such issues as advances in technology, mechanics, cost, user preference, etc., other first connectors, such as hydraulic, truss, springs, gravity, magnetic, other non-screws, etc., may suffice.

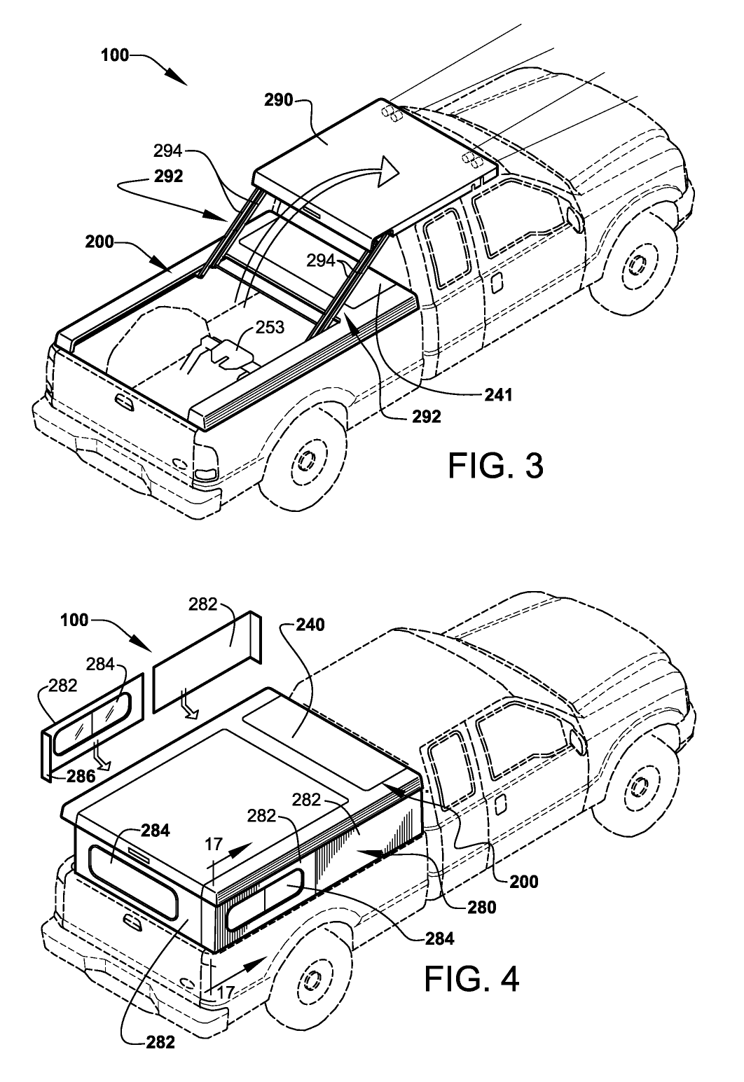

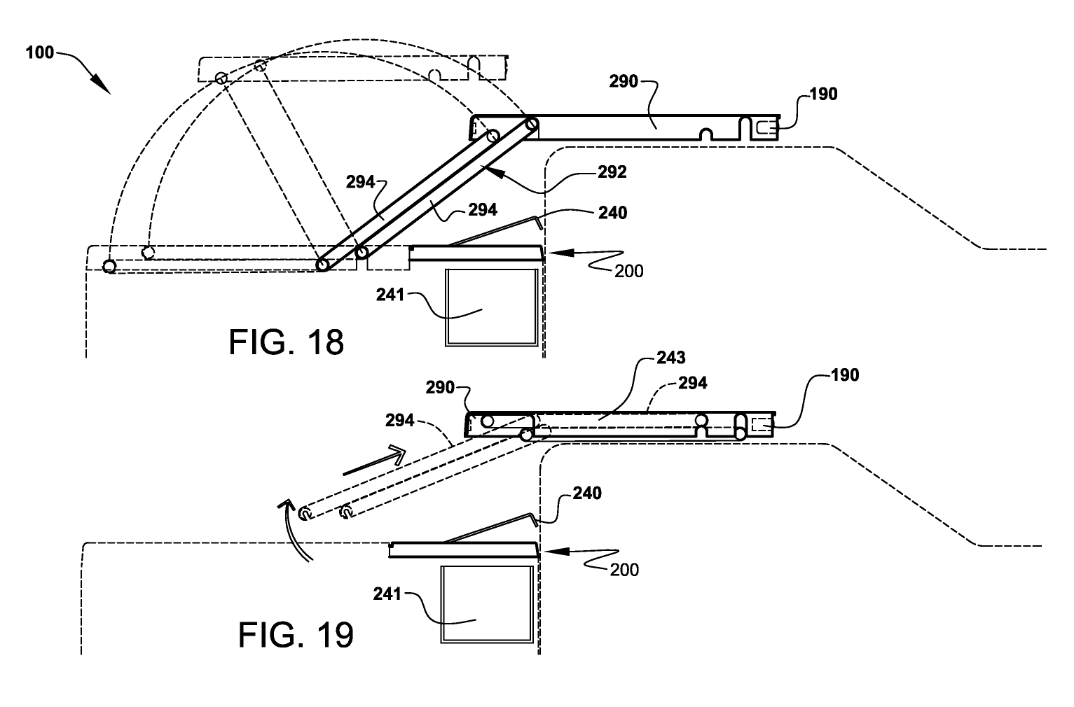

FIG. 3 shows a perspective view of a repositionable cover portion 290, according to the preferred embodiment of FIG. 1. Bed cover 200 preferably comprises repositionable cover portion 290. Repositionable cover portion 290 preferably comprises second connector 292, preferably comprising four arms 294, as shown in FIGS. 18 and 19. Second connectors 292, preferably arms, as shown, preferably connect repositionable cover portion 290 to bed cover 200. Repositionable cover portion 290 is preferably substantially adapted to move substantially onto a second portion of truck 110, preferably comprising roof 114, as shown in FIGS. 18 and 19. This preferred feature provides access to the interior of cargo bed 112 during operation of truck 110. Repositionable cover portion 290 thus provides a means for accessing a bed-mounted fifth wheel hitch 253, which may be used to pull a wheeled trailer.

FIG. 4 shows a perspective view of demountable enclosure parts, according to the preferred embodiment of FIG. 1, in an installed position. System 100 preferably comprises demountable enclosure 280, preferably providing for demountable enclosure of a portion of truck 110, preferably for demountable enclosure of cargo bed 112 when bed cover 200 is in raised position 211, as shown. Demountable enclosure 280 preferably comprises five panels 282, preferably comprising windows 284, preferably enclosing a first portion of truck 110, preferably comprising the cargo bed 112 of truck 110, as shown. Demountable enclosure 280 (at least embodying herein at least one demountable enclosure structured and arranged to demountably enclose at least one open area formed substantially between the at least one cargo bed and such at least one bed cover, when such at least one bed cover is moved to such at least one raised position) preferably also comprises attachers 286 so as to assist in attaching panels 282 to bed cover 200 and cargo bed 112, as shown in FIG. 17. Preferably, panels 282 comprise interlocking vertical edges to assist stable interlocking of adjacent panels. Preferably, panels 282 are constructed from a rigid material, preferably plastic, alternately preferably a fiber-reinforced composite material.

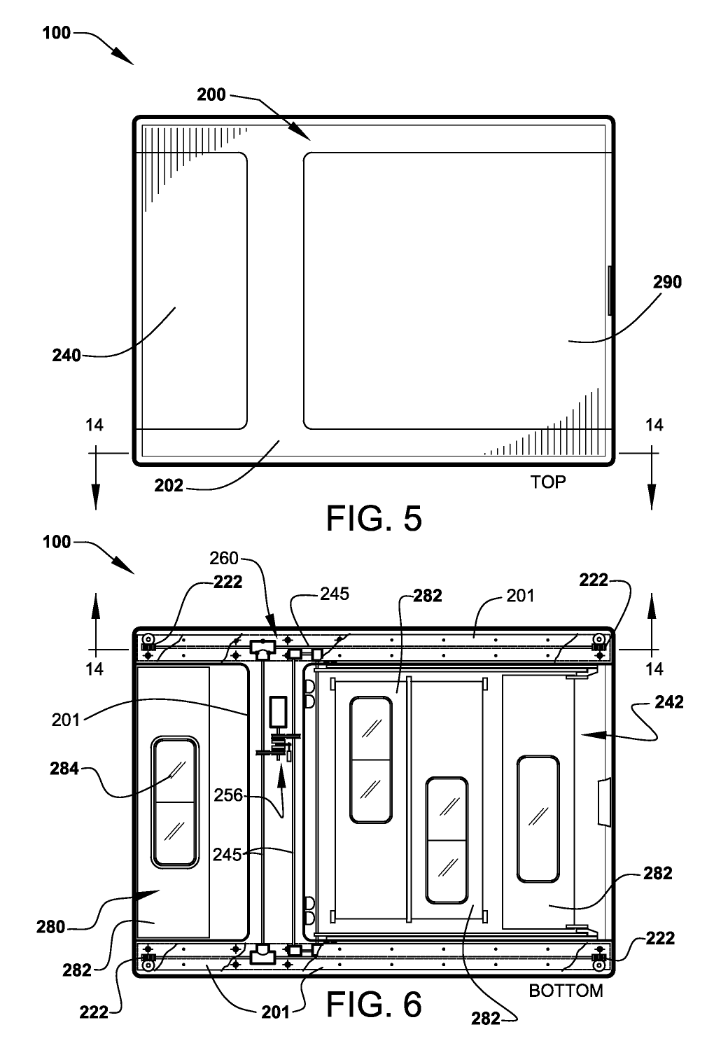

FIG. 5 shows a top view of bed cover 200, according to the preferred embodiment of FIG. 1. Bed cover 200 preferably comprises a storage access portion identified herein as storage access door 240, as shown (at least embodying herein wherein such at least one bed cover comprises at least one storage access portion structured and arranged to provide access to such at least one in-bed storage unit when such at least one bed cover is in such at least one bed-covering position). Preferably, storage access door 240 is structured and arranged to provide convenient access to bed storage unit 241, preferably for storing random item, such as tools equipment, personal items, etc., as shown in FIG. 2. Bed storage unit 241 preferably comprises a tool box (at least embodying herein at least one in-bed storage unit structured and arranged to assist in-bed storage of at least one item substantially within the at least one cargo bed). Upon reading the teachings of this specification, those with ordinary skill in the art will now understand that, under appropriate circumstances, considering such issues as advances in technology, cost, user preference, etc., other in-bed storage configurations, such as a configuration on the other end of the bed cover, removable, non-rectangular compartments, storage boxes integral to the cargo bed cover, etc., may suffice.

FIG. 6 shows an underside view of bed cover 200, according to the preferred embodiment of FIG. 1. The underside of bed cover 200 preferably comprises enclosure storage area 242, preferably adjacent inner surface 201, so as to provide storage for panels 282 when panels 282 are not enclosing bed 112, as shown (at least embodying herein wherein such at least one bed cover comprises at least one enclosure storage structured and arranged to store such at least one demountable enclosure when demounted from the at least one cargo bed). The underside of bed cover 200 further houses motorizer 250 that preferably enables the motorized operation of bed cover 200, as further described below.

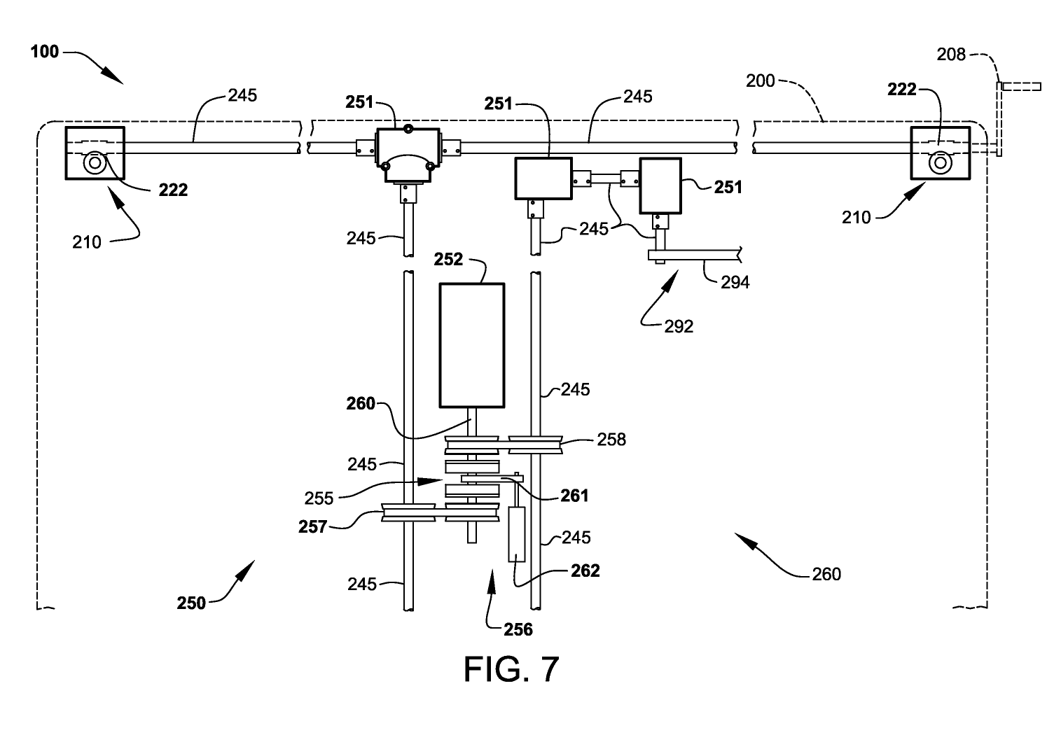

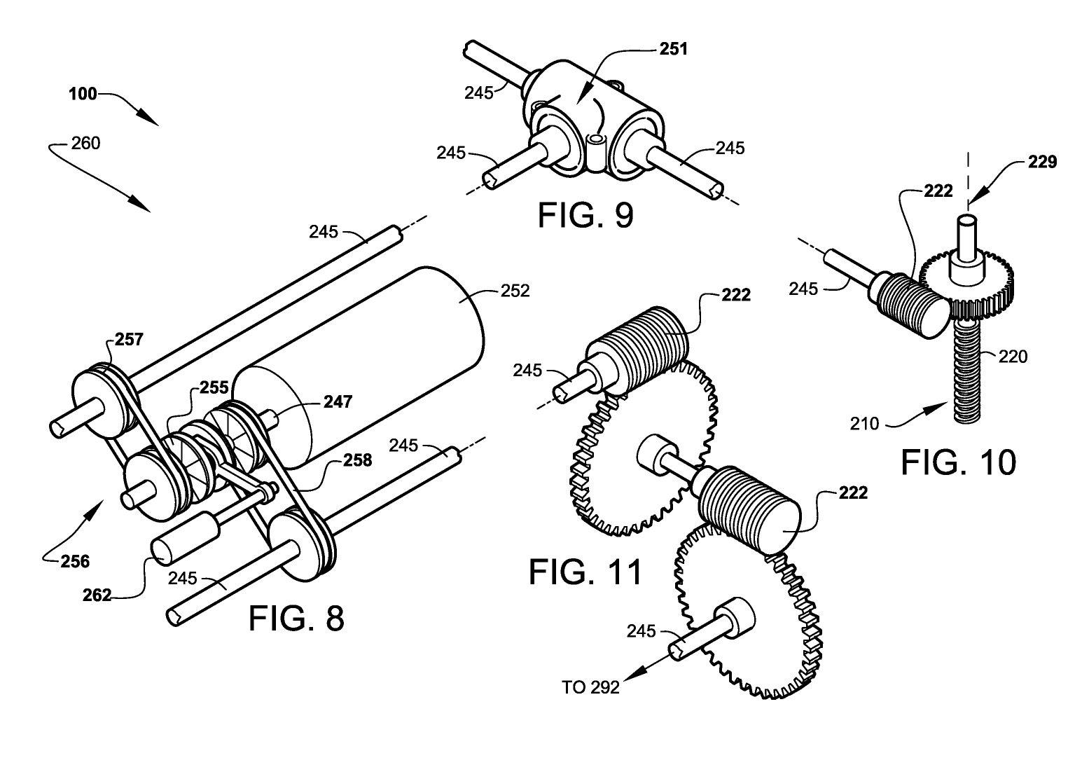

FIGS. 7-13 show various views of motorizer 250 according to the preferred embodiment of FIG. 1. Motorizer 250 is preferably located substantially between outer surface 202 and the protective inner surface 201, preferably positioned to be substantially concealed from view, as best shown in FIG. 1. Motorizer 250 preferably comprises drive train 260, as shown. FIG. 7 is a view to the underside of bed cover 200 illustrating one half of drive train 260. Drive train 260 is preferably designed to enable both powered lifting and lowering of bed cover 200 and powered operation of repositionable cover portion 290. In general terms, motorized movement of bed cover 200, between bed-covering position 209 and raised position 211 is preferably enabled by a rotation of screw shafts 220 by drive train 260. A preferred arrangement of screw shafts 220 and preferred integration of the screw assemblies within cargo bed 112 is shown in FIG. 14.

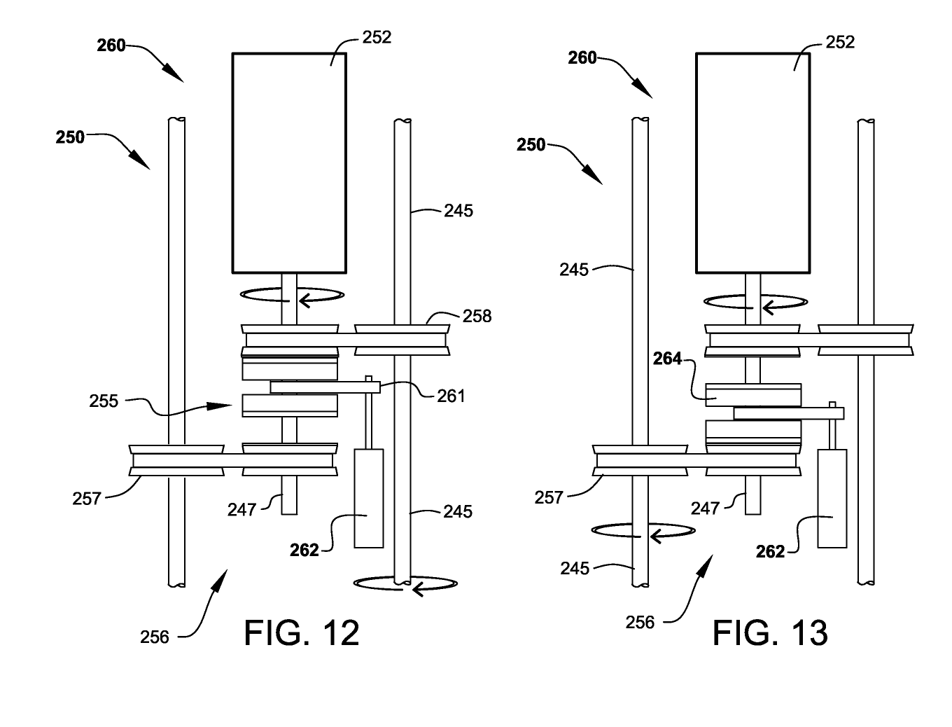

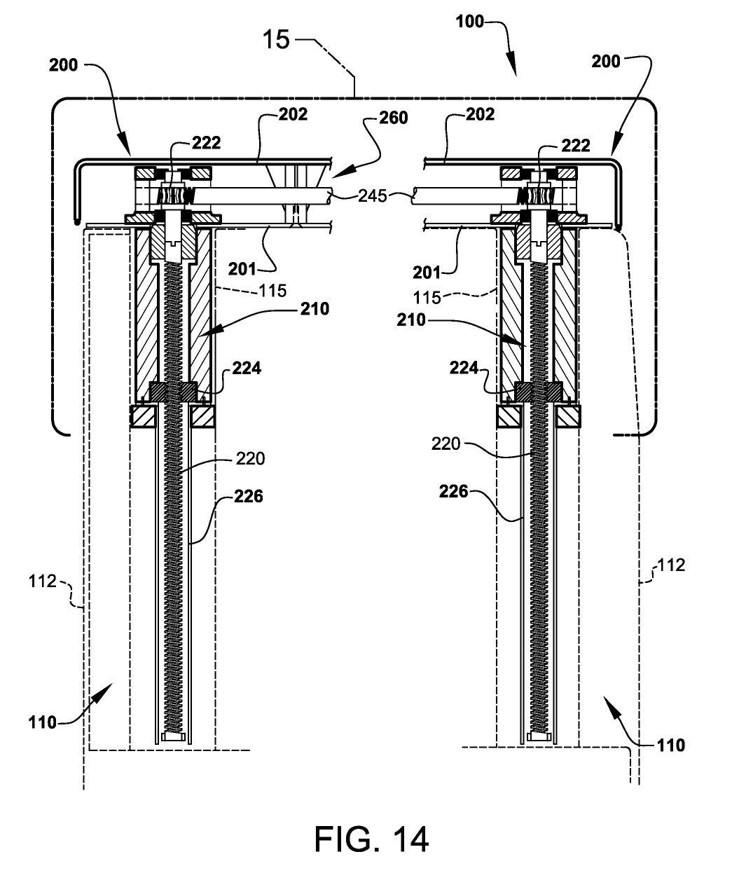

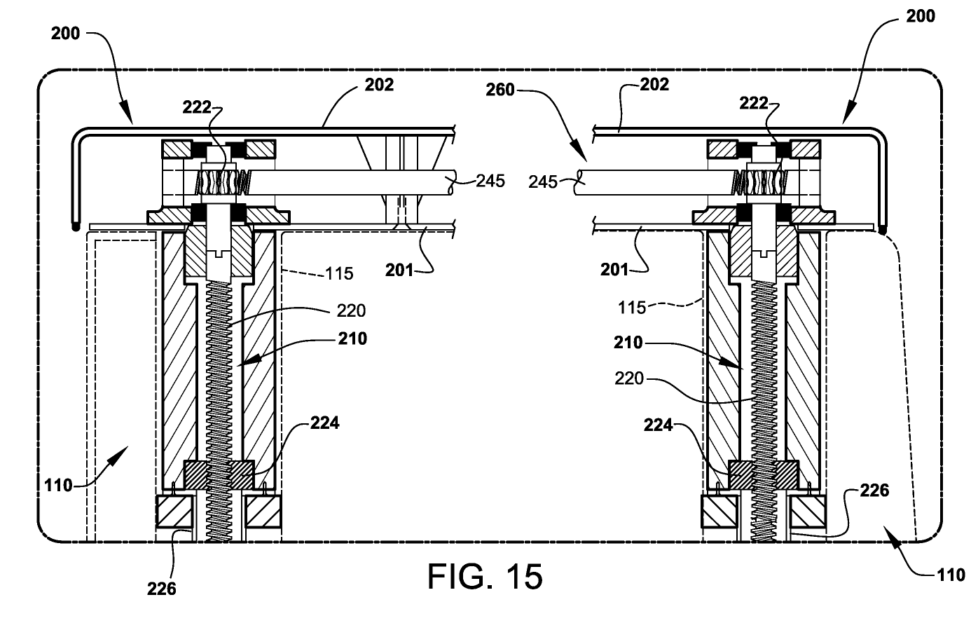

Preferably, drive train 260 at least comprises electrically-driven motor 252, transmission 256, rotational shafts 245, gear boxes 251, and worm gear assemblies 222, as shown. Preferably, a single electrically-driven motor 252 produces the rotational force used to drive the preferred operations of bed cover 200. The rotational force generated by electrically-driven motor 252 preferably passes through transmission 256 before being distributed along an arrangement of rotational shafts 245 and gear boxes 251, as shown. Preferably, transmission 256 is structured and arranged to selectively transfer the rotational force of electrically-driven motor 252 between lifting/lowering of bed cover 200 and powered deployment of repositionable cover portion 290. Preferably, transmission 256 (at least embodying herein at least one selectable power director structured and arranged to selectably direct such at least one rotational force between such at least one first connector and such at least one second connector) comprises a two-way frictional clutch 255 movable along drive shaft 247 between a first position in contact with transfer-belt assembly 257, as best shown in FIG. 13, and a second position in contact with transfer-belt assembly 258, as best shown in FIG. 12. Transfer-belt assembly 257 preferably transfers a rotational force between drive shaft 247 and of the operable portion of drive train 260 functioning to lift/lower bed cover 200, as shown. Transfer-belt assembly 258 preferably transfers a rotational force between drive shaft 247 and the operable portion of drive train 260 functioning to enable the powered deployment of repositionable cover portion 290, as shown. Movement of two-way frictional clutch 255 between the two positions is preferably enabled by a clutch-engaging fork member 261 coupled to electrical solenoid 262, as shown.

Drive train 260 preferably comprises worm gear 222, preferably at least four worm gears 222, preferably located directly above first connectors 210 so as to provide raising and lowering of bed cover 200, as shown. Worm gears 222 are preferred for their ability to control both operational speed and torque levels within drive train 260. A highly preferred advantage of the above-described design is the coordination of rotational speeds between individual screw shafts. More specifically, bed cover 200 preferably comprises four peripheral corners 281, each one preferably comprising a screw shaft 220, as shown. By operating each screw shaft 220 from a common drive train 260, each of the screw shafts are contemporaneously rotated in a highly coordinated manner, thus, a high degree of operational coordination is achieved during lifting and lowering of the cover. Upon reading the teachings of this specification, those of ordinary skill in the art will now understand that, under appropriate circumstances, considering such issues as intended use, cost, etc., other rotator arrangements, such as providing a dedicated high torque motor at each screw shaft with electronic-based coordination, utilizing independent drive trains for cover lifting and sub panel deployment, etc., may suffice. Furthermore, upon reading the teachings of this specification, those with ordinary skill in the art will now understand that, under appropriate circumstances, considering such issues as advances in technology, mechanics, cost, space, user preference, etc., other transmissions, such as transmissions without worm gears, electric, magnetic, pulley, non-gear transmissions, non-belt transmissions, etc., may suffice.

Motorizer 250 preferably comprises user-operable switch 263, so as to provide switching between lifting and lowering of bed cover 200, and deployment of repositionable cover portion 290. User-operable switch 263 (at least embodying herein at least one controller structured and arranged to control motorized operation of such at least one motorizer) preferably comprises a remote control and/or a controller switch located inside the cab 113 of truck 110 (see FIG. 1). Preferably, motorizer 250 comprises a power supply, preferably the power supply of truck 110. Upon reading the teachings of this specification, those with ordinary skill in the art will now understand that, under appropriate circumstances, considering such issues as advances in technology, cost, user preference, etc., other power supplies, such as dedicated battery, solar, chemical, etc., may suffice System 100 may also comprise access for a removable crank 208, so as to provide cranked movement of bed cover 200 should motorizer 250 fail. Accommodations necessary to incorporate crank 208 into the motorized system (e.g., sockets, engagements, etc.) may be placed at one or more convenient points within drive train 260, as shown in FIG. 7 (at least embodying herein wherein such at least one bed cover comprises at least one hand crank structured and arranged to assist in the performance of at least one hand-cranked rotation of such at least one screw shaft; wherein the axis of such at least one screw shaft comprises a substantially vertical orientation; and wherein such hand-cranked rotation of such at least one screw shaft moves such at least one bed cover substantially along the axis of such at least one screw shaft between at least one bed-covering position located substantially adjacent the at least one cargo bed and at least one raised position located above the at least one cargo bed).

FIG. 14 shows a side view of the worm gears and connectors, with bed cover 200 in a closed position (bed-covering position 209), according to the preferred embodiment of FIG. 1. FIG. 15 shows an enlarged side view of the worm gears and connectors, with the bed cover in bed-covering position 209, according to the preferred embodiment of FIG. 1.

First connector 210 preferably comprises a positionally-fixed collar 224, so as to provide anchored linear movement of screw shafts 220 along vertical axis 229 when motorizer 250 is actuated, preferably installed in the walls of bed 112, preferably threaded consistently with screw shafts 220, as shown. First connector 210 preferably comprises a hollow neck 226, so as to provide a semi-protected space for screw shafts 220 to move vertically, as shown.

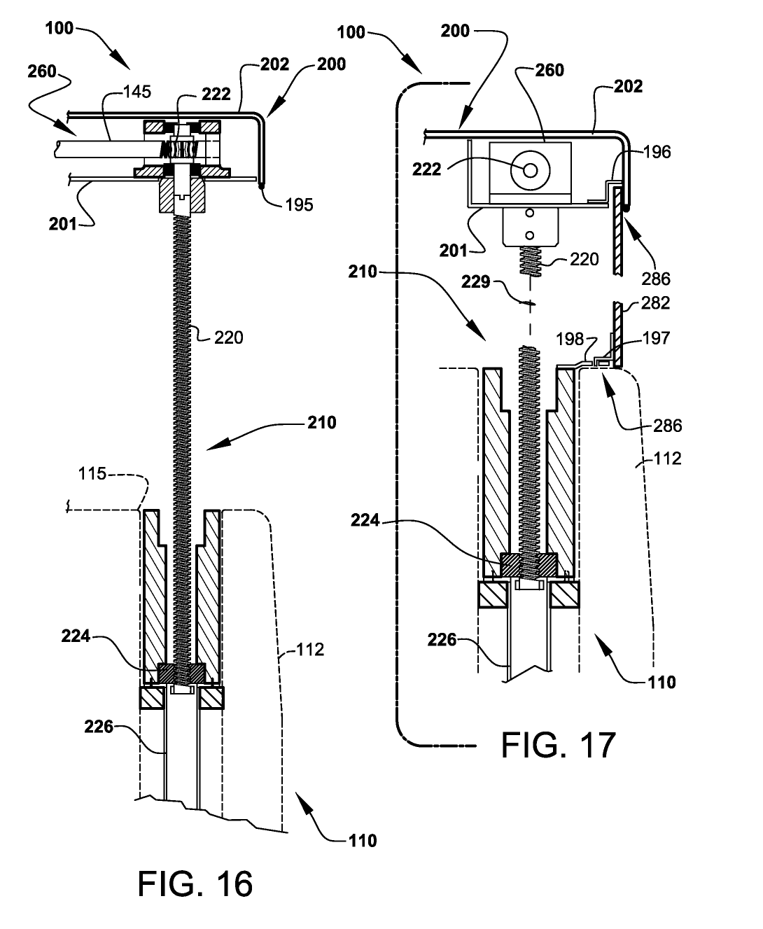

FIG. 16 shows a side view of the worm gears and connectors, with the bed cover in an opened position, according to the preferred embodiment of FIG. 1. FIG. 17 shows an enlarged side view of the worm gears and connectors, with bed cover 200 in an opened position (raised position 211), according to the preferred embodiment of FIG. 1. Thus, the previously described structures and arrangements at least embodying herein wherein such at least one first connector comprises at least one threaded collar structured and arranged to collar such at least one screw shaft; and such at least one threaded collar is fixedly coupled to the at least one cargo bed; such at least one motorizer is structured and arranged to rotate at least one screw shaft; such at least one threaded collar is maintained in a substantially fixed position relative to the at least one cargo bed during such rotation; and such rotation of such at least one screw shaft results in a substantially vertical translational movement of such at least one screw shaft through such at least one threaded collar. And, wherein such at least one first connector further comprises: at least four of such at least one screw shafts operationally engaging a matching number of such at least one threaded collars.

FIG. 17 also shows a preferred engagement of attachers 286 preferably attaching panels 282 to bed cover 200 and cargo bed 112. Upper attachers 286 preferably comprise the engagement of panels 282 within a peripheral socket 196, as shown. Lower attachers 286 preferably comprise a set of Z-shaped projections 197, coupled to panels 282 that preferably engage corresponding socket members 198 mounted to the upper surface of cargo bed 112, as shown. It is noted that bed cover 200 further comprises an arrangement of moisture seals 195 adapted to restrict infiltration of moisture into cargo bed 112.

FIG. 18 shows a side view illustrating repositionable cover portion 290 retracting onto roof 114 of the truck 110 according to the preferred embodiment of FIG. 1. FIG. 19 shows a side view illustrating repositionable cover portion 290 with detachable and storable second connectors 292, according to the preferred embodiment of FIG. 1. System 100 preferably comprises third storage 243. Second connector preferably substantially detaches from truck 110 and stores inside repositionable cover portion 290, where repositionable cover portion 290 preferably comprises third storage 243, as shown. Preferably, a set of illuminating projectors 190 are incorporated integrally within the front face of repositionable cover portion 290, as shown. Such illuminating projectors 190 preferably comprise driving lights of one or more commercially available designs.

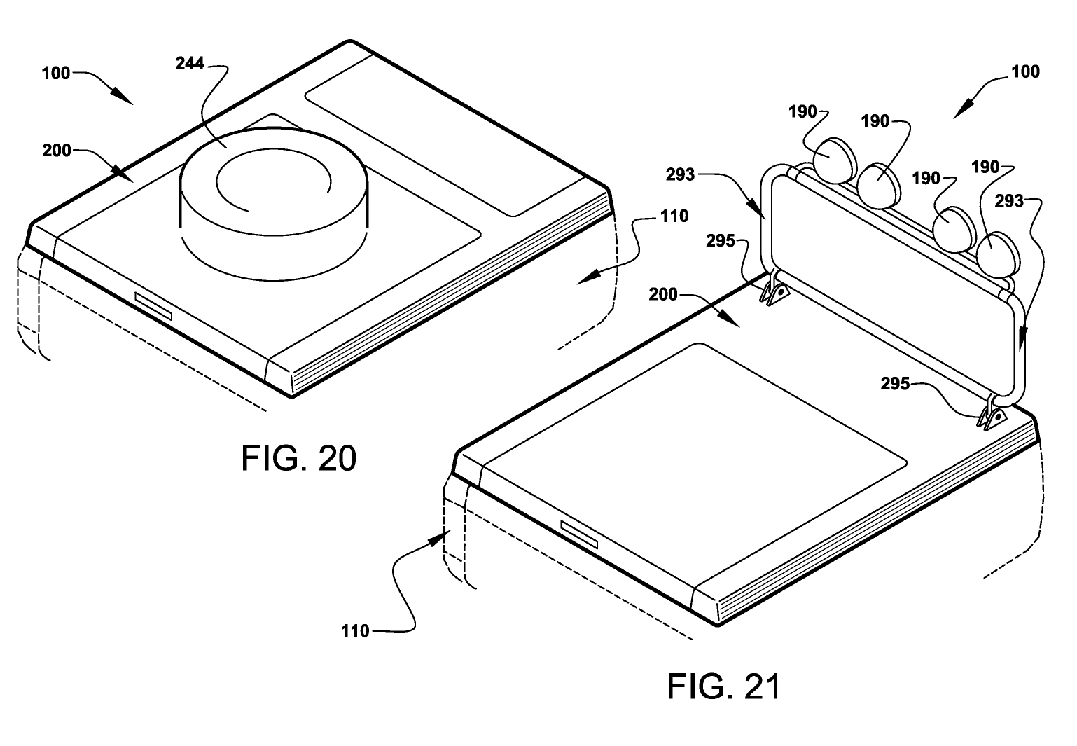

FIG. 20 shows a perspective view of a wheel storage area, according to another preferred embodiment of the present invention. System 100 preferably comprises fourth storage 244, so as to provide storage for a wheel, preferably a spare wheel, as shown.

FIG. 21 shows a perspective view of an illuminating projecting light, according to another preferred embodiment of the present invention. FIG. 22 shows a side view of the illuminating projecting light, according to the preferred embodiment of FIG. 21. System 100 preferably comprises illuminating projector 190, preferably a lamp containing a bulb light or LED, as shown. Illuminating projector 190 preferably comprises third connector 293, preferably an extended third connector 293, so as to provide a source of light extended above truck 110, as shown. Illuminating projector 190 preferably comprises hinge 295, so as to provide for hinged movement of illuminating projector 190, preferably a collapsible hinge 295, so as to reduce the overhead clearance of truck 110, as shown. Such illuminating projectors 190 preferably comprise driving lights of one or more commercially available designs. The above-described structures and arrangements preferably at least embody wherein such at least one bed cover comprises at least one illuminator structured and arranged to provide illumination adjacent the at least one truck; wherein such at least one illuminator comprises at least one third connector structured and arranged to connect such at least one illuminator to such at least one bed cover; and wherein such at least one third connector comprises at least one pivot structured and arranged to assist pivotal movement of such at least one illuminator relative to such at least one bed cover.

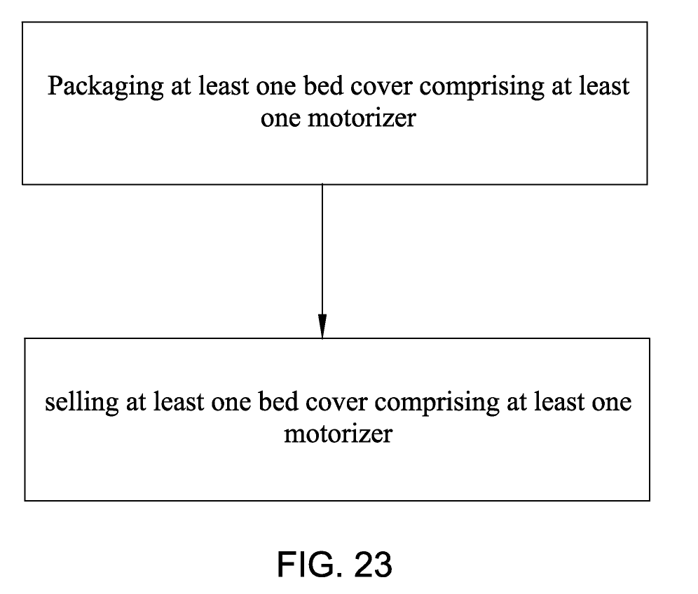

FIG. 23 shows a diagram illustrating another truck cover system according to another preferred embodiment of system 100. Truck cover system 100 preferably comprises a method, related to a truck having a bed cover 200 comprising a motorizer 250, comprising the steps of: (1) packaging a bed cover 200, and (2) selling a bed cover 200.

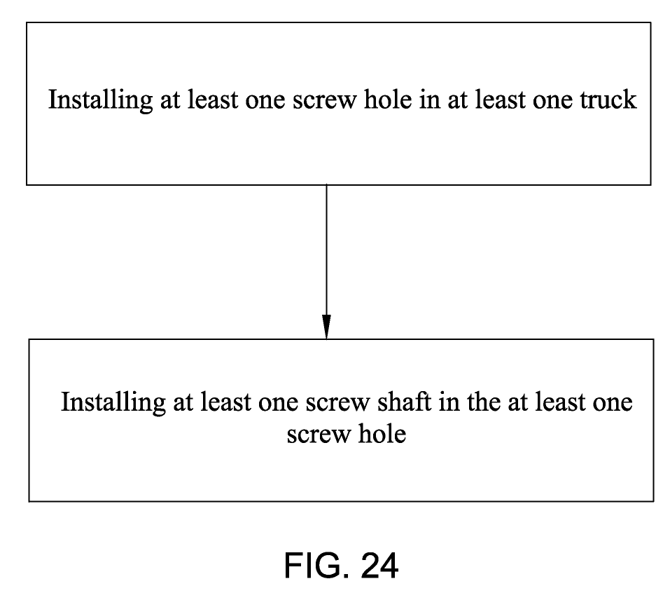

FIG. 24 shows a diagram illustrating another truck cover system according to another preferred embodiment of the present invention. Truck cover system 100 preferably comprises a method related to a truck having a bed cover 200, a screw shaft 220 having a vertical axis 229, and a screw hole 221, preferably comprising the steps of: (1) installing the screw hole 221 in the truck, and (2) installing the a screw shaft 220 in the screw hole 221, whereby the screw shaft 220 provides for movement of bed cover 200 substantially along vertical axis 229.

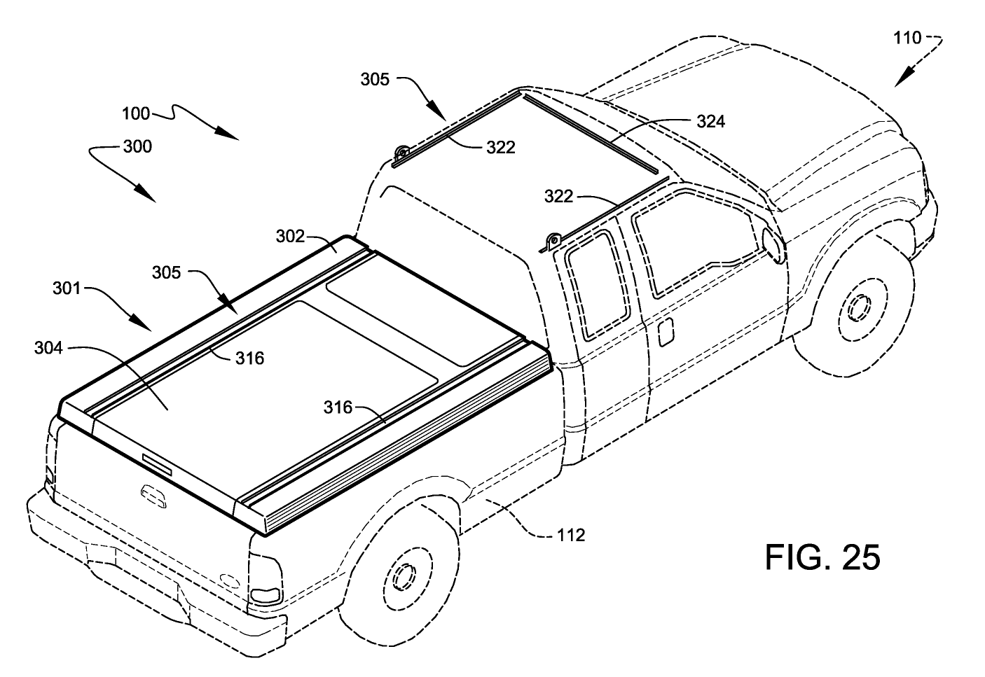

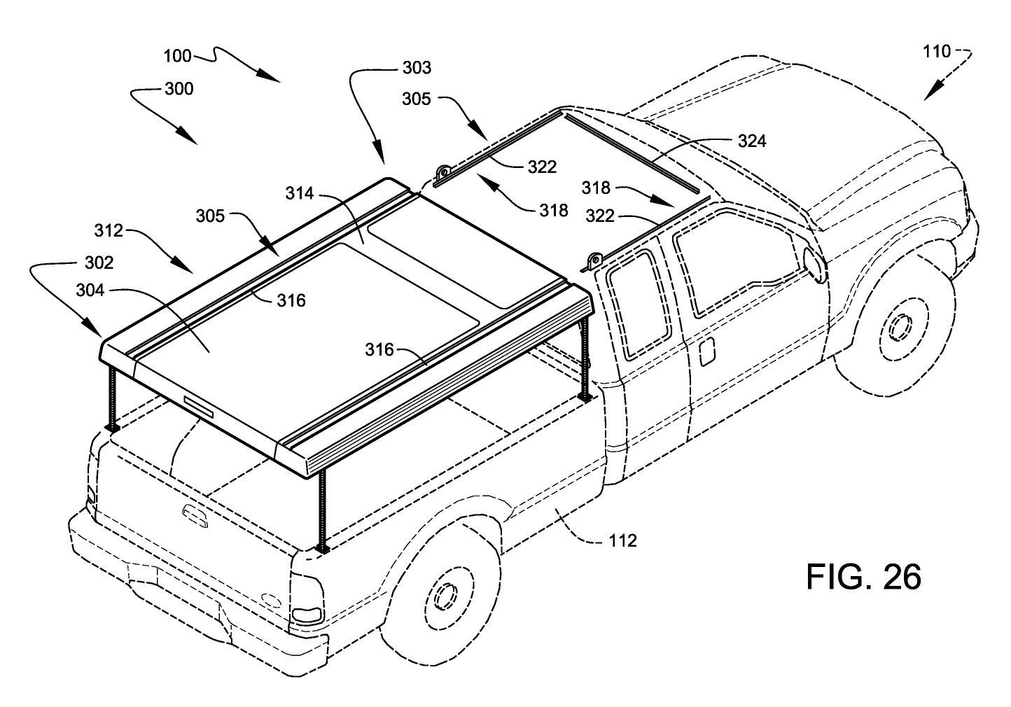

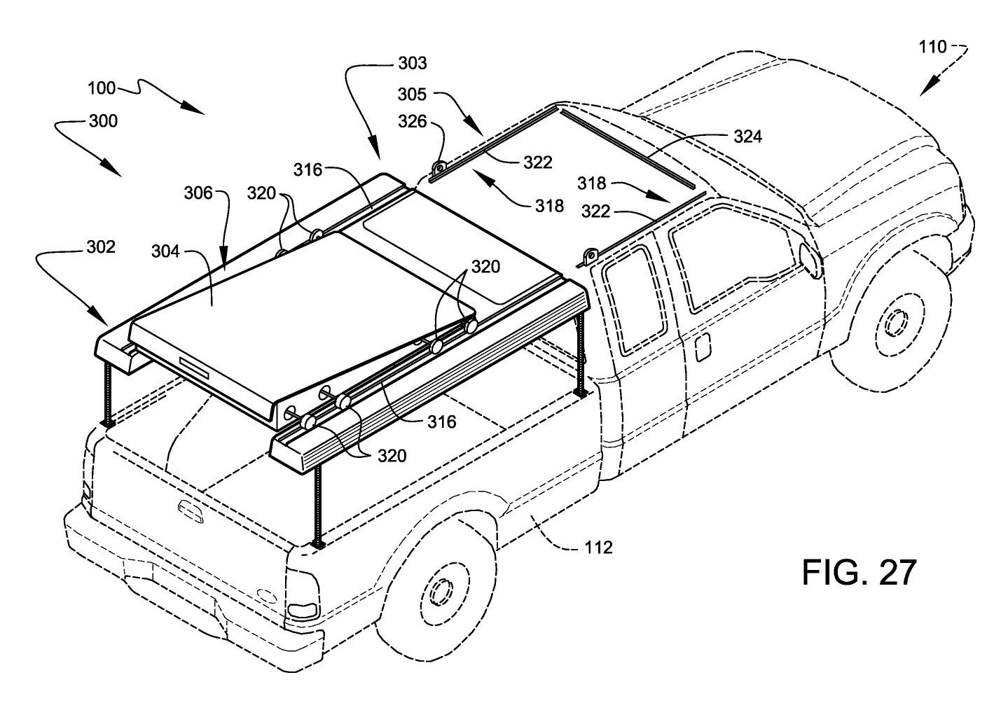

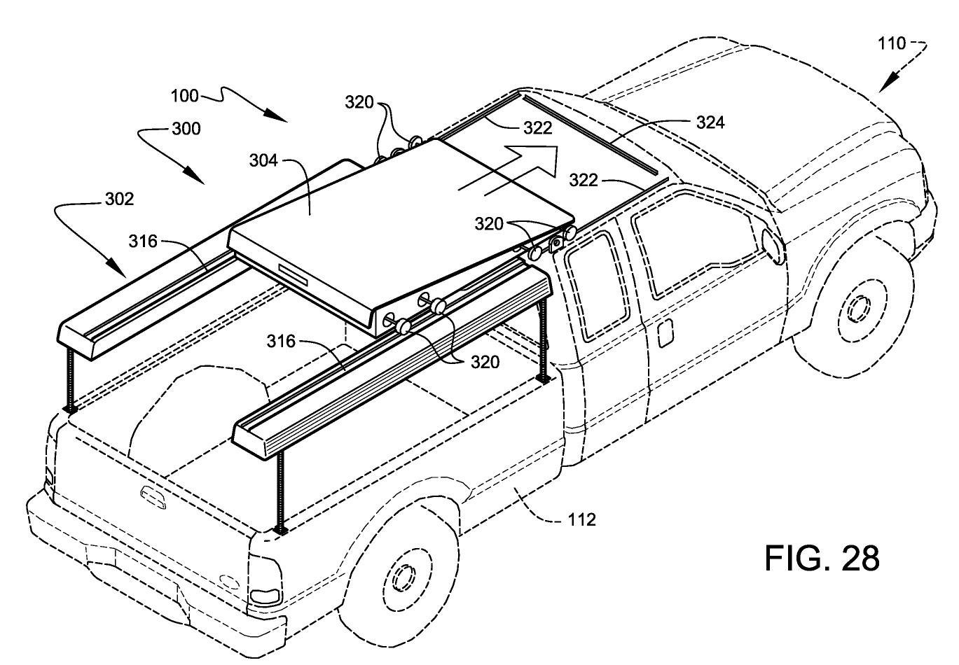

FIG. 25 through FIG. 29 generally illustrates alternate truck cover 300 performing a preferred sequence of deployment steps as it is configured to allow access to bed 112. FIG. 25 shows a perspective view, illustrating alternate truck cover 300 positioned adjacent the cargo bed 112 of truck 110, according to another preferred embodiment of system 100. FIG. 26 shows a perspective view, illustrating alternate truck cover 300 in raised position 312, according to the preferred embodiment of FIG. 25. FIG. 27 shows the same perspective view, with alternate truck cover 300 in raised position 312, illustrating repositionable cover portion 304 transitioning upwardly to moveable position 306. FIG. 28 shows the same perspective view, with repositionable cover portion 304 translating forward to an overhead deployed position 308 over roof 114 of truck 110.

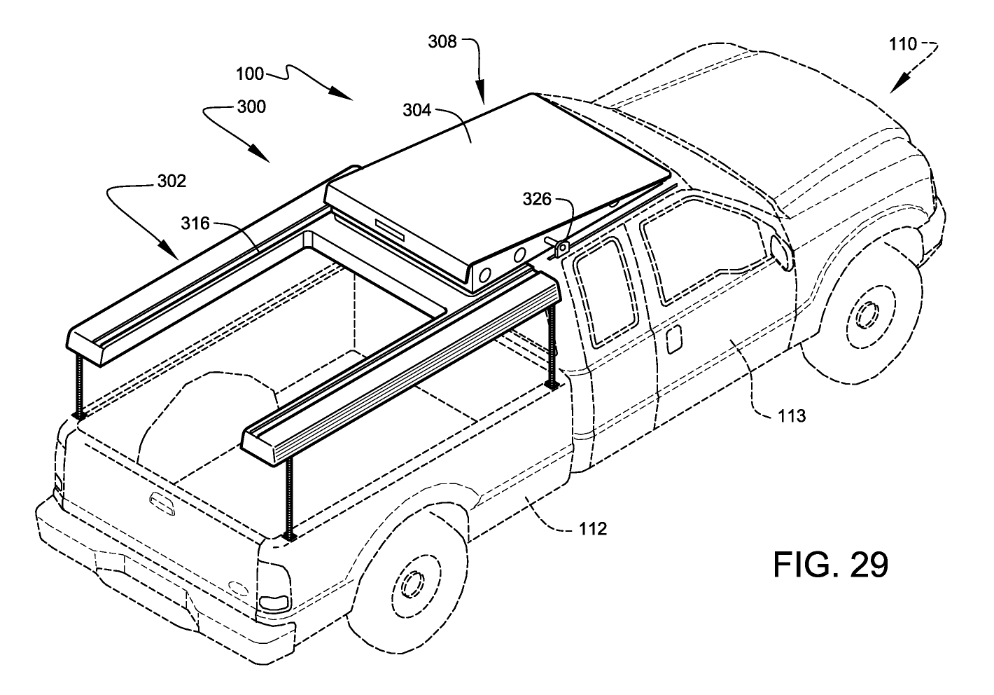

Alternate truck cover 300 preferably comprises bed cover portion 302 having a repositionable cover portion 304 located therein, as shown. Alternate truck cover 300 preferably comprises deployment subsystem 303 designed to allow repositionable cover portion 304 to move from stowed position 301, as shown in FIG. 25, to deployed position 308, as shown in FIG. 29. More specifically, repositionable cover portion 304 is preferably adapted to disengage from bed cover portion 302 and perform a low-friction movement along track assembly 305 to deployed position 308 located substantially adjacent roof 114 of cab 113, as shown in FIG. 29. This preferred feature provides access to the interior of cargo bed 112 during operation of truck 110. Repositionable cover portion 304 thus provides a means for accessing a bed-mounted fifth wheel hitch 253 (see also FIG. 3), which may be used to pull a wheeled trailer.

The above-described reconfiguration of alternate truck cover 300 preferably begins with the raising of bed cover portion 302 vertically from bed-covering position 310 (located substantially adjacent cargo bed 112) to raised position 312 located above cargo bed 112, as shown in FIG. 26. This preferably places the upper outer surface 314 of bed cover portion 302 at an elevation substantially matching that of roof 114, as shown. The preferred structures and arrangements of bed cover portion 302, associated with the above-described raising operation, are substantially similar to those described in the prior embodiments. Thus, alternate truck cover 300 preferably comprises structures and arrangements equivalent to first connector 210, drive train 260, etc.

Preferably, track assembly 305 comprises cover-mounted guide 316 and roof-mounted guide 318, as shown. Preferably, cover-mounted guide 316 and roof-mounted guide 318 are maintained in close physical alignment when bed cover portion 302 is in raised position 312, as shown.

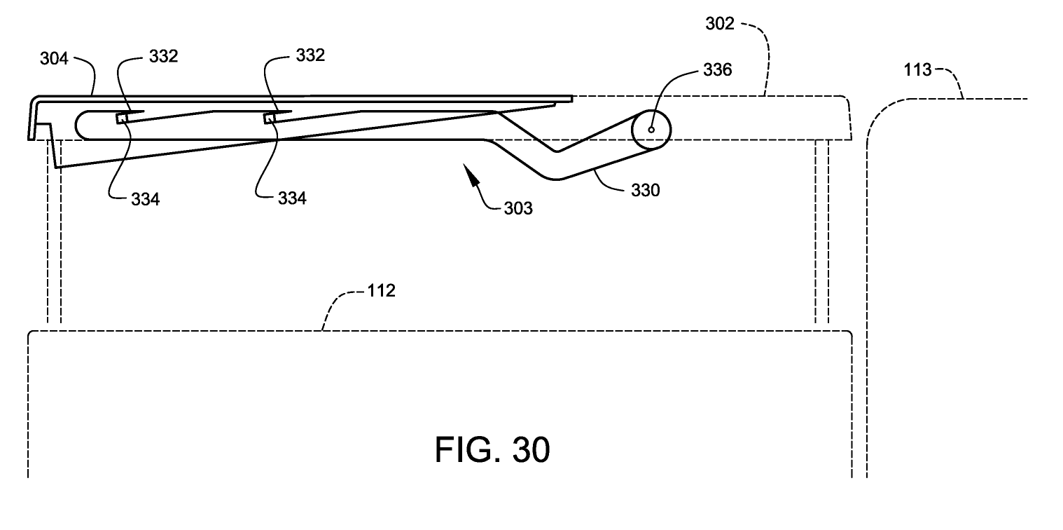

Next, repositionable cover portion 304 is preferably raised from bed cover portion 302 to moveable position 306 and subsequently configured to enable a preferred low-friction movement along track assembly 305. Preferred means for disengagement and lifting of repositionable cover portion 304 from bed cover portion 302 is discussed in FIG. 30 below. Preferably, such disengagement and lifting of repositionable cover portion 304 from bed cover portion 302 further comprises the deployment of friction-reducing support members, most preferably a plurality of rollers 320, as shown. Preferably, rollers 320 are deployed from repositionable cover portion 304 generally concurrently with the repositionable cover portion 304 is lifted from bed cover portion 302, as shown. Preferably, rollers 320 are adapted to engage cover-mounted guide 316 that preferably functions to maintain rollers 320 and repositionable cover portion 304 in proper alignment during movement. Preferably, cover-mounted guide 316 comprises a substantially linear recess formed within upper outer surface 314, as shown. The preferred spacing of rollers 320, as diagrammatically depicted in FIG. 27, assists in maintaining the continuous support of repositionable cover portion 304 as the front portion of the panel is transferred from cover-mounted guide 316 to roof-mounted guide 318.

FIG. 28 shows a perspective view of repositionable cover portion 304 of FIG. 27 translating toward the forward deployed position 308 over cab 113 of truck 110. Preferably, roof-mounted guides 318 comprise a set of surface-applied guide tracks 322 firmly mounted to roof 114 of cab 113, as shown. Preferably, repositionable cover portion 304 is rolled forward until it engages forward stop 324. Preferably, forward stop 324 functions to limit the forward travel of repositionable cover portion 304 and engages repositionable cover portion 304 to prevent uplift during operation of truck 110. Alternately preferably, engagement of repositionable cover portion 304 on forward stopped 324 may initiate an automatic retraction of rollers 320 to a stowed position within repositionable cover portion 304. FIG. 29 shows repositionable cover portion 304 of FIG. 27 in a final preferred deployed position 308 over cab 113 of truck 110.

Once repositionable cover portion 304 resides in the preferred deployed position 308, repositionable cover portion 304 is preferably locked in place using locking assembly 326, as shown. Preferably, locking assembly 326 functions to maintain repositionable cover portion 304 in deployed position 308, as shown in FIG. 29. Preferably, actuation of locking assembly 326 is manually initiated by the user. Alternately preferably, engagement of repositionable cover portion 304 on forward stopped 324 automatically initiates the actuation of locking assembly 326. Preferably, once repositionable cover portion 304 is locked into the preferred deployed position 308, bed cover portion 302 may again be lowered to bed-covering position 310. Thus, the repositioning of repositionable cover portion 304 enables substantial access to cargo bed 112, even when bed cover portion 302 is in bed-covering position 310.

FIG. 30 shows a first schematic diagram illustrating the preferred operational arrangements of repositionable cover portion 304 of FIG. 27. FIG. 30 comprises a schematic side view of repositionable cover portion 304 and the underlying deployment subsystem 303, as shown. Cargo bed 112, bed-cover portion 302, and cab 113 are illustrated in a dashed-line depiction for clarity.

Preferably, deployment subsystem 303 comprises a pair of pivoting lift arms 330 situate adjacent each side of repositionable cover portion 304, as shown. Preferably, each pivoting lift arm 330 comprises a set of engageable slots 332 adapted to engage a complementing set of projecting bars 334 that are preferably coupled to cover portion 304.

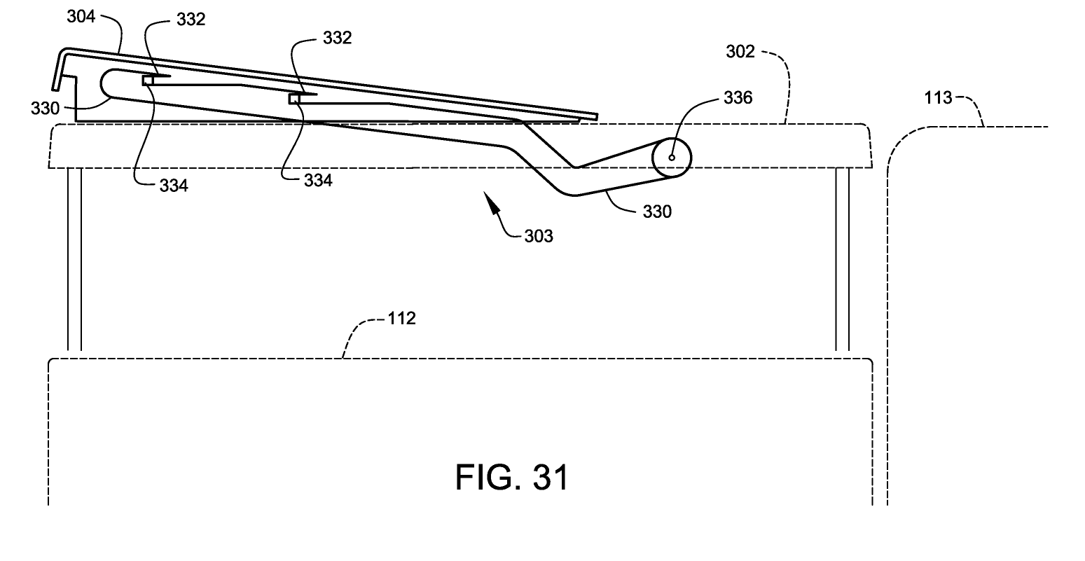

FIG. 31 shows a second schematic diagram illustrating the preferred operational arrangements of repositionable cover portion 304. Preferably, pivoting lift arms 330 are rotationally coupled to repositionable cover portion 304 and are preferably adapted to rotate about pivot point 336, as shown. Preferably, pivoting lift arms 330 comprise an upwardly biased force designed to assist in lifting repositionable cover portion 304 to the “lifted” moveable position 306 depicted in FIG. 31. Preferably, such lifting may be enabled by a spring force and may preferably be controlled by a user initiated release. Upon reading the teachings of this specification, those of ordinary skill in the art will now understand that, under appropriate circumstances, considering such issues as intended use, cost, etc., other lift arrangements, such as pneumatic devices, hydraulic devices, electrical actuators, etc., may suffice.

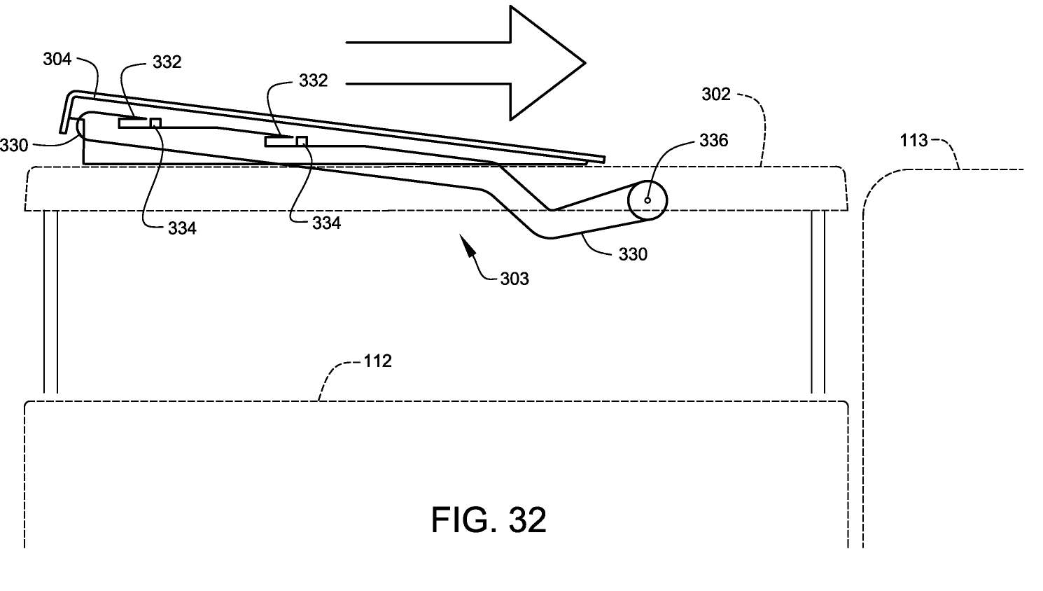

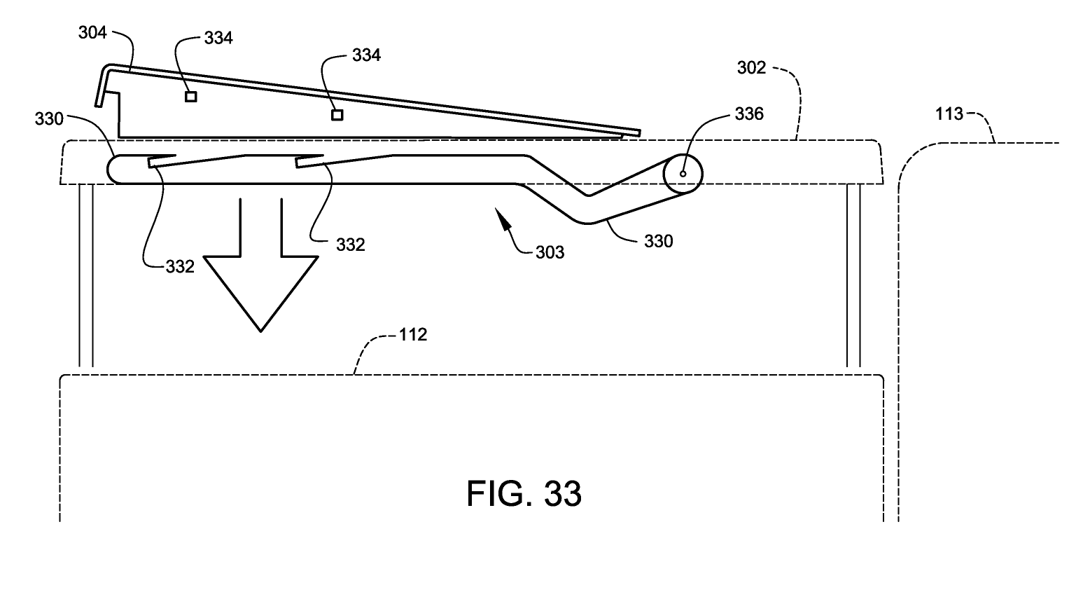

FIG. 32 shows a third schematic diagram further illustrating the preferred operational arrangements of repositionable cover portion 304 of FIG. 27. Preferably, when in moveable position 306, engageable slots 332 are arranged to allow repositionable cover portion 304 to translate in a forward direction generally parallel to cover-mounted guide 316 of upper outer surface 314, as shown. Preferably, repositionable cover portion 304 is moved forward until projecting bars 334 are vertically clear of engageable slots 332, as shown. This preferably allows pivoting lift arms 330 to be pivoted downward, as illustrated in FIG. 33.

FIG. 33 shows a fourth schematic diagram further illustrating the preferred operational arrangements of repositionable cover portion of FIG. 27. The preferred downward rotation of pivoting lift arms 330 preferably enables the deployment of rollers 320 and unencumbered forward movement of repositionable cover portion 304 to deployed position 308, as described above. The above-described preferred deployment operations lend themselves to both automatic and manual implementation. Upon reading the teachings of this specification, those of ordinary skill in the art will now understand that, under appropriate circumstances, considering such issues as cost, vehicle type, etc., other deployment arrangements, such as manually moving a panel to a deployed position, the utilization of the low-friction slides in lieu of rollers, etc., may suffice.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A system, related to covering at least one cargo bed of at least one truck having at least one cab, said system comprising:
a) at least one bed cover, having at least one inner surface and at least one outer surface, said at least one bed cover structured and arranged to substantially cover the at least one cargo bed; and
b) at least one first connector structured and arranged to connect said at least one bed cover to the at least one cargo bed;
c) wherein said at least one bed cover comprises at least one motorizer structured and arranged to motorize movement of said at least one bed cover;
d) wherein said at least one motorizer is located substantially adjacent said at least one inner surface;
e) wherein said at least one first connector comprises at least one screw shaft; and
f) wherein said at least one motorizer is structured and arranged to move said at least one bed cover substantially along the axis of said at least one screw shaft.

2) The system according to claim 1 wherein:
a) the axis of said at least one screw shaft comprises a substantially vertical orientation; and
b) said at least one bed cover is structured and arranged to translate substantially vertically between at least one bed-covering position located substantially adjacent the at least one cargo bed and at least one raised position located above the at least one cargo bed.

3) The system according to claim 2 further comprising at least one demountable enclosure structured and arranged to demountably enclose at least one open area formed substantially between the at least one cargo bed and said at least one bed cover, when said at least one bed cover is moved to such at least one raised position.

4) The system according to claim 3 wherein said at least one bed cover comprises at least one enclosure storage structured and arranged to store said at least one demountable enclosure when demounted from the at least one cargo bed.

5) The system according to claim 1 further comprising:
a) at least one in-bed storage unit structured and arranged to assist in-bed storage of at least one item substantially within the at least one cargo bed;
b) wherein said at least one bed cover comprises at least one storage access portion structured and arranged to provide access to said at least one in-bed storage unit when said at least one bed cover is in such at least one bed-covering position.

6) The system according to claim 1 wherein said at least one bed cover comprises:
a) at least one repositionable cover portion structured and arranged to provide partial access to the at least one cargo bed when said at least one bed cover is in such at least one bed-covering position; and
b) at least one second connector structured and arranged to substantially connect said at least one repositionable cover portion to said at least one bed cover;
c) wherein said at least one second connector comprises at least one relocator structured and arranged to relocate said at least one repositionable cover portion from at least one stowed position substantially within said at least one bed cover to at least one deployed position substantially adjacent the at least one cab; and
d) wherein, when said at least one repositionable cover portion is in such at least one deployed position, access to the at least one cargo bed is provided.

7) The system according to claim 6 wherein such relocation of said at least one repositionable cover portion by said at least one relocator is assisted by said at least one motorizer.

8) The system according to claim 7 wherein said at least one second connector comprises:
a) at least one detacher structured and arranged to enable detachment of said at least one second connector from said at least one bed cover;
b) wherein said at least one bed cover comprises at least one connector storage structured and arranged to store said at least one second connector;
c) wherein said at least one second connector is storable within said at least one connector storage after such detachment.

9) The system according to claim 1 wherein said at least one bed cover comprises at least one illuminator structured and arranged to provide illumination adjacent the at least one truck.

10) The system according to claim 9 wherein said at least one illuminator comprises:
a) at least one third connector structured and arranged to connect said at least one illuminator to said at least one bed cover;
b) wherein said at least one third connector comprises at least one pivot structured and arranged to assist pivotal movement of said at least one illuminator relative to said at least one bed cover.

11) The system according to claim 1 wherein said at least one bed cover comprises at least one wheel storage area structured and arranged to store at least one road wheel of the at least one truck.

12) The system according to claim 2 wherein:
a) said at least one first connector comprises at least one threaded collar structured and arranged to collar said at least one screw shaft; and
b) said at least one threaded collar is fixedly coupled to the at least one cargo bed;
c) said at least one motorizer is structured and arranged to rotate at least one screw shaft;
d) said at least one threaded collar is maintained in a substantially fixed position relative to the at least one cargo bed during such rotation; and
e) such rotation of said at least one screw shaft results in a substantially vertical translational movement of said at least one screw shaft through said at least one threaded collar.

13) The system according to claim 12 wherein said at least one first connector further comprises:
a) at least four of said at least one screw shafts operationally engaging a matching number of said at least one threaded collars;
b) wherein said at least one motorizer comprises at least one drive train structured and arranged to contemporaneously rotate each one of said at least one screw shafts.

14) The system according to claim 13 wherein said at least one drive train comprises:
a) at least one electrically driven motor structured and arranged to provide at least one rotational force;
b) coupled to said at least one electrically driven motor, as least one rotational shaft structured and transfer such at least one rotational force away from said at least one electrically driven motor; and
c) at least one worm gear structured and arranged to adjust torque levels within said at least one drive train.

15) The system according to claim 14 wherein:
a) said at least one bed cover comprises at least four peripheral corners; and
b) each one of said at least four peripheral corners comprises one said at least one screw shaft.

16) The system according to claim 1 further comprising at least one controller structured and arranged to control motorized operation of said at least one motorizer.

17) The system according to claim 6 further comprising at least one selectable power director structured and arranged to selectably direct such at least one rotational force between said at least one first connector and said at least one second connector.

18) The system according to claim 19 wherein said at least one relocator comprises:
a) at least one roller structured and arranged to assist rolling movement of said at least one repositionable cover portion from such at least one stowed position to such at least one deployed position;
b) at least one guide track structured and arranged to guide said at least one roller during such rolling movement

19) The system according to claim 6 wherein said at least one relocator comprises:
a) at least one roller structured and arranged to assist rolling movement of said at least one repositionable cover portion from such at least one stowed position to such at least one deployed position;
b) at least one guide track structured and arranged to guide said at least one roller during such rolling movement; and
c) at least one positional lock structured and arranged to positionally lock said at least one repositionable cover portion in such at least one deployed position;
d) wherein said at least one guide track comprises
i) at least one cover-mounted portion structured and arranged to assist such rolling movement over said at least one bed cover, and
ii) at least one cab-mounted portion structured and arranged to assist such rolling movement over the at least one cab.

20) A system, related to covering at least one cargo bed of at least one truck having at least one cab, said system comprising:
a) at least one bed cover structured and arranged to cover the at least one cargo bed; and
b) at least one first connector structured and arranged to movably connect said at least one bed cover to the at least one cargo bed;
c) wherein said at least one first connector comprises at least one screw shaft; and
d) wherein said at least one bed cover comprises at least one hand crank structured and arranged to assist in the performance of at least one hand-cranked rotation of said at least one screw shaft;
e) wherein the axis of said at least one screw shaft comprises a substantially vertical orientation;
f) wherein such hand-cranked rotation of said at least one screw shaft moves said at least one bed cover substantially along the axis of said at least one screw shaft between at least one bed-covering position located substantially adjacent the at least one cargo bed and at least one raised position located above the at least one cargo bed.

21) A system, related to at least one truck having at least one cab and at least one cargo bed, said system comprising:
a) at least one cargo-bed cover structured and arranged to substantially cover said at least one cargo bed;
b) at least one repositionable cover portion structured and arranged to provide partial access to the at least one cargo bed when covered by said at least one cargo bed cover; and
c) at least one connector structured and arranged to connect said at least one repositionable cover portion to said at least one bed cover;
d) wherein said at least one connector comprises at least one relocator structured and arranged to relocate said at least one repositionable cover portion from at least one stowed position substantially within said at least one bed cover to at least one deployed position substantially adjacent the at least one cab; and
e) wherein, when said at least one repositionable cover portion is in such at least one deployed position, partial access to the at least one cargo bed is provided.

22) A system, related to at least one truck having at least one cargo-bed cover having at least one motorizer, comprising the steps of:
a) packaging the at least one cargo-bed cover; and
b) selling the at least one cargo-bed cover;
c) wherein the at least one cargo-bed cover comprises the at least one motorizer.

23) A method related to covering at least one cargo bed of at least one truck, said method comprising the steps of:
a) mounting at least one screw shaft receiver in the at least one cargo bed; and
b) mounting at least one screw shaft in the at least one screw shaft receiver;
c) coupling at least one motor-driven rotator to such at least one screw shaft;
d) mounting at least one cargo-bed cover to such at least one screw shaft;
e) wherein rotation of the at least one screw shaft by the at least one motor-driven rotator provides movement of the at least one bed cover substantially along the at least one screw shaft.
